(19) United States
(12) Patent Application Publication
(10) Pub. No.: US 2014/0160563 A1
(43) Pub. Date: Jun. 12, 2014

(54) IMAGE DISPLAY APPARATUS

(71) Applicant: KABUSHIKI KAISHA TOSHIBA, TOKYO (JP)

(72) Inventors: Hiroshi HASEGAWA, Tokyo (JP); Shinichi TATSUTA, Tokyo (JP)

(73) Assignee: KABUSHIKI KAISHA TOSHIBA, TOKYO (JP)

(21) Appl. No.: 14/101,885

(22) Filed: Dec. 10, 2013

(30) Foreign Application Priority Data
Dec. 10, 2012 (JP) 2012-269201

(51) Int. Cl. G02B 27/22

(52) U.S. Cl. CPC G02B 27/2214
USPC 359/463

(57) ABSTRACT

According to one embodiment, an apparatus includes a projection unit, a change unit, and a separation unit. The projection unit projects first rays containing parallax image components. The change unit receives the first rays projected from the projection unit, collimates the first rays, and causes second rays to emerge. The separation unit receives the second rays emerging from the change unit, separates the parallax image components contained in the second rays at angles corresponding to the parallax image components, and projects the parallax image components to a viewing area. The separation unit includes a lenticular lens in which cylindrical lens elements are arrayed and boundaries are set between adjacent cylindrical lens elements. The parallax image components pass through areas of the cylindrical lens elements except for the boundaries.

### CROSS-REFERENCE TO RELATED APPLICATIONS

This application is based upon and claims the benefit of priority from Japanese Patent Application No. 2012-269201, filed Dec. 10, 2012, the entire contents of which are incorporated herein by reference.

### FIELD

Embodiments described herein relate generally to an image display apparatus.

### BACKGROUND

Various methods have been known in the field of 3D video display apparatuses capable of displaying a moving image, called 3D displays, as image display apparatuses. Recently, demand is high for a flat panel type image display apparatus requiring no dedicated glasses or the like. In a 3D video display apparatus of a type requiring no dedicated glasses, a ray control element is installed immediately before a display panel (display apparatus) in which the pixel position is fixed, such as a direct-view or projection liquid crystal display apparatus or a plasma display apparatus. Rays traveling from the display panel are controlled to be directed to a viewer. The ray control element has a function of giving stereopsis of a video which changes depending on the viewing angle even when the same position on the ray control element is viewed.

Three-dimensional image display methods using such ray control elements are classified into a two-view type, multi-view type, super multi-view type (super multi-view condition of the multi-view type), integral imaging (to be also referred to as II hereinafter) type, and the like depending on the number of parallaxes (difference of viewing when an object is viewed from different directions) and the design guide. The two-view method gives stereopsis based on binocular parallax. The remaining methods can implement motion parallax more or less, and videos implemented by these methods are called 3D videos in distinction from two-view stereoscopic videos. The basic principle for displaying these 3D videos is substantially the same as the principle of integral photography (IP) which was invented almost 100 years before and is applied to 3D photographs.

There is a method of projecting an image to a lenticular lens in an image display apparatus which enables stereopsis by displaying parallax images in a plurality of directions. This method allows the viewer to experience stereopsis by using the fact that rays entering individual cylindrical lenses forming the lenticular lens are deflected to emerge in different directions in accordance with their incident positions. More specifically, a projection image to be projected from an image projector to the lenticular lens contains a plurality of parallax images. These parallax images are deflected to emerge in respective directions via the lenticular lens. The parallax images can be displayed for respective rays traveling in the respective directions, allowing the viewer to experience stereopsis.

In this lenticular lens method, the lenticular lens has a function of separating a projection image into parallax images. In general, when an image is projected from an image projector, enlarged, and displayed, rays entering the lenticular lens diverge. A ray toward the center and a ray toward the periphery enter the lenticular lens at different incident angles. For this reason, the deflection angles of rays emerging from the lenticular lens also differ between the center and periphery of the screen. All the parallax images cannot be displayed for viewing by the viewer, impairing stereopsis. To solve this problem, there is known a method in which a Fresnel lens having a convex lens function is interposed between the image projector and the lenticular lens, and projection rays are collimated and enter the lenticular lens.

Generally, a Fresnel lens has convex lens surfaces formed of a plurality of band-like areas concentrically separated, and a step is formed at a boundary between band-like areas where lens surfaces are discontinuous. If a certain area or more is required as a lens and a convex lens function is given to the lens, a resin Fresnel lens is generally used, because a convex lens made of glass or optical resin is difficult to handle in terms of manufacturing accuracy and weight.

In a three-dimensional image display system, rays which form a parallax image are incident on not only the continuous surface but also the step portion of the Fresnel lens. The rays incident on the step portion are scattered by the step and cannot be incident on a lenticular lens at a desired angle. Of the rays scattered at the step, scattered rays directed upward and downward will cause noise in an image, whereas scattered rays in a parallax separation direction will be mixed with another parallax image. Accordingly, there is a problem that image quality of the displayed parallax image may be degraded.

As described above, an optical system having a Fresnel lens which changes a ray angle between an image projector and a parallax separation element such as a lenticular lens has a problem that a step portion scatters projection rays and accordingly degrades image quality of a parallax image.

### BRIEF DESCRIPTION OF THE DRAWINGS

FIG. 1 is a plan view in the horizontal plane and a side view in the vertical plane, respectively, schematically showing the optical arrangement of an image display apparatus according to the first embodiment;

FIG. 2 is a plan view in the horizontal plane and a side view and rear-side plan view in the vertical plane, respectively, schematically showing the structure of an integrated lens shown in FIG. 1;

FIG. 3 is an explanatory view schematically showing the ray trace of the optical system in which an image pattern is projected to the structure of the integrated lens shown in FIG. 1 and rays emerge from the integrated lens toward the viewer according to the first embodiment;

FIG. 4 is a flowchart showing a process to create the image pattern shown in FIG. 3;

FIG. 5 is an explanatory view schematically showing the ray trace of an optical system in which an image pattern is projected to the structure of the integrated lens shown in FIG. 1 and rays emerge from the integrated lens toward the viewer according to the second embodiment;

FIG. 6 is a flowchart showing a process to create the image pattern shown in FIG. 5;

FIG. 7 is a plan view in the horizontal plane and a side view and rear-side plan view in the vertical plane, respectively, schematically showing the structure of an integrated lens in an image display apparatus according to the third embodiment;

FIG. 8 is a plan view in the horizontal plane and a side view and rear-side plan view in the vertical plane, respectively, schematically showing the structure of an integrated lens in an image display apparatus according to the fourth embodiment;

FIGS. 9A and 9B are schematic views showing ray traces and viewable ranges in the image display apparatus according to the first embodiment shown in FIG. 2 and the image display apparatus according to the fourth embodiment shown in FIG. 8;

FIG. 10 is a plan view in the horizontal plane and a side view in the vertical plane, respectively, schematically showing the optical arrangement of an image display apparatus according to the fifth embodiment;

FIG. 11 is a plan view in the horizontal plane and a side view and rear-side plan view in the vertical plane, respectively, schematically showing the structure of an integrated lens in the image display apparatus shown in FIG. 10;

FIG. 12 is a perspective view schematically showing the structure of the integrated lens in the image display apparatus shown in FIG. 10;

FIG. 13 is a plan view in the horizontal plane and a side view and rear-side plan view in the vertical plane, respectively, schematically showing the structure of an integrated lens in an image display apparatus according to the sixth embodiment;

FIG. 14 is a plan view in the horizontal plane and a side view in the vertical plane, respectively, schematically showing an image display apparatus according to the seventh embodiment;

FIG. 15 is an explanatory view schematically showing the ray traces of projection pixels and a first lenticular lens in the horizontal parallax plane in an optical system according to the seventh embodiment;

FIGS. 16A, 16B, and 16C are explanatory views showing a plane arrangement in which two-dimensional projection pixels (parallax image components) represented by parallax numbers are projected on the rear surface of a first lenticular lens, and are explanatory views showing the arrangement relationship between first and second lenticular lenses, and an explanatory view showing the projection direction of two-dimensional projection pixels (parallax image components) emerging from a second lenticular lens 1114 to the front of the viewer;

FIG. 17 is a plan view in the horizontal plane and a side view in the vertical plane, respectively, schematically showing an image display apparatus according to the eighth embodiment;

FIG. 18 is a plan view in the horizontal plane and a side view in the vertical plane, respectively, schematically showing an image display apparatus according to the ninth embodiment; and

FIG. 19 is a plan view in the horizontal plane and a side view, respectively, schematically showing an image display apparatus according to the 10th embodiment.

### DETAILED DESCRIPTION

An image display apparatus according to an embodiment will now be described with reference to the accompanying drawings.

An embodiment has been made in consideration of the above circumstances, and its object is to provide an image display apparatus which enables stereopsis by preventing degradation of image quality of a parallax image.

According to the embodiments, an image display apparatus includes a ray projection unit, a ray angle change unit, and a parallax separation unit. The ray projection unit projects first rays containing a plurality of parallax image components. The ray angle change unit receives the first rays projected from the ray projection unit, substantially collimates the first rays, and causes second rays to emerge. The parallax separation unit receives the second rays emerging from the ray angle change unit, separates the parallax image components contained in the second rays at angles corresponding to the parallax image components, and projects the parallax image components to a viewing area. The parallax separation unit includes a lenticular lens in which cylindrical lens elements are arrayed and boundaries are set between adjacent cylindrical lens elements. The parallax image components pass through areas of the cylindrical lens elements except for the boundaries.

In this specification, “horizontal” and “vertical” are defined with respect to the two eyes of a viewer 2, and do not mean “horizontal” and “vertical” defined strictly. That is, a field of view in which the two eyes are arranged, and a plane almost parallel to this field of view are defined as a horizontal plane (horizontal field of view), and a plane almost perpendicular to the horizontal plane is defined as a vertical plane (vertical field of view). Also, in this specification, the side of the viewer 2 with respect to an image display unit 102 is defined as the front side, and the side of an image projector 101 is defined as the rear side. A viewing area where the viewer 2 can view a stereoscopic image displayed on the image display unit 102 is set in front of the image display unit 102.

### First Embodiment

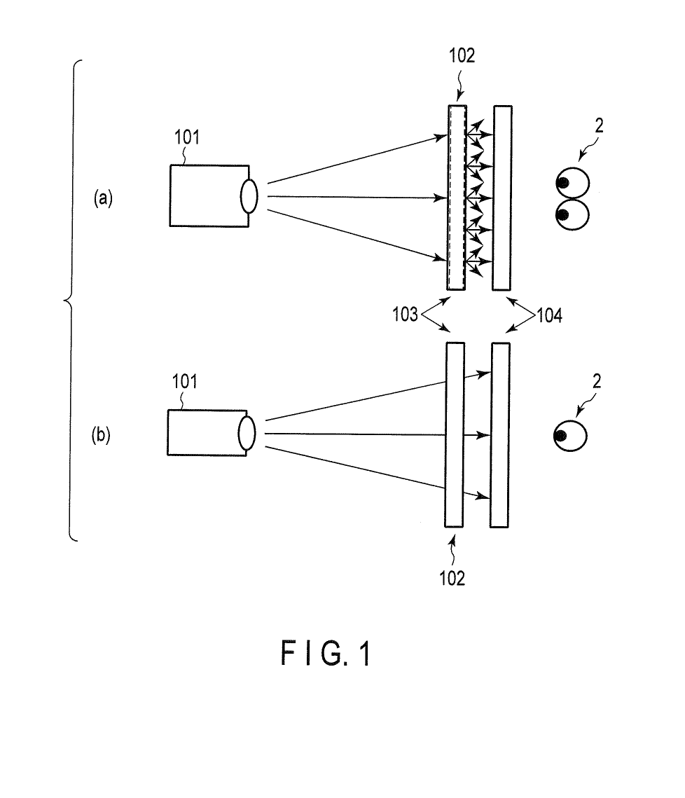

FIG. 1 shows the arrangement of an optical system in the horizontal field of view and the vertical field of view in an image display apparatus according to the first embodiment. In (a) of FIG. 1, both the eyes of a viewer 2 are illustrated to represent an optical system in the horizontal field of view (horizontal plane). In (b) of FIG. 1, one eye of the viewer 2 is illustrated to represent an optical system in the vertical field of view (vertical plane). The viewer 2 is positioned in front of an image display unit 102, views the image display unit 102, and can stereoscopically view an image displayed on the image display unit 102.

An image projector 101 is arranged on the rear side of the image display unit 102. The image projector 101 projects an image to the image display unit 102, and the projected image is observed as a stereoscopic image (3D image). The image display unit 102 includes an integrated lens 103 and diffusion plate 104. The integrated lens 103 almost collimates projection rays contained in an image projected on the image display unit 102 in the horizontal field of view. The integrated lens 103 separates parallax image components contained in the projection image, and projects them to the diffusion plate 104. “Almost collimate” is not limited to a case in which projection rays enter the diffusion plate 104 strictly parallelly. Projection rays may slightly diverge and enter the diffusion plate 104 so as to project a slightly enlarged projection image. Alternatively, projection rays may slightly converge and enter the diffusion plate 104 so as to project a slightly reduced projection image. By displaying parallax images on the diffusion plate 104, the viewer can recognize a stereoscopic image on the front or rear side of the diffusion plate 104.

An image to be stereoscopically viewed by the viewer is generated by capturing an object by many cameras arranged on a given reference plane, and editing a plurality of parallax images from these cameras. An image to be stereoscopically viewed by the viewer may be generated by creating parallax images at a plurality of viewpoints by calculation from an image created by rendering, and editing these parallax images. In editing parallax images, parallax image components (parallax image segments) are extracted from the parallax images and combined to generate an image to be stereoscopically viewed by the viewer. This image is displayed on the image display unit 102. Therefore, a parallax image component corresponds to an image component or image segment extracted from a parallax image captured by one camera. In displaying with stereopsis in only the horizontal direction, a parallax image component corresponds to an image segment strip cut out from a parallax image.

FIG. 1 shows an optical system which gives parallax (horizontal parallax) in only the horizontal field of view. Also in the following description, embodiments of an image display apparatus which gives horizontal parallax will be explained. However, even an embodiment of an image display apparatus which can give vertical parallax even in the vertical field of view, in addition to horizontal parallax in the horizontal field of view, can be easily implemented by applying the optical system which gives horizontal parallax, as an optical system in the vertical field of view. More specifically, when parallaxes (horizontal and vertical parallaxes) are to be given in the horizontal and vertical fields of view, the image projector 101 emits, to the integrated lens 103, parallax images which give parallaxes in the horizontal and vertical fields of view in a projection image. Then, the integrated lens 103 collimates the projection rays in the vertical and horizontal fields of view, separates parallax images which are contained in the projection image and give horizontal and vertical parallaxes, and projects them onto the diffusion plate 104. Similarly, it should be understood that the following description includes an embodiment of an image display apparatus capable of giving parallaxes in the horizontal and vertical fields of view.

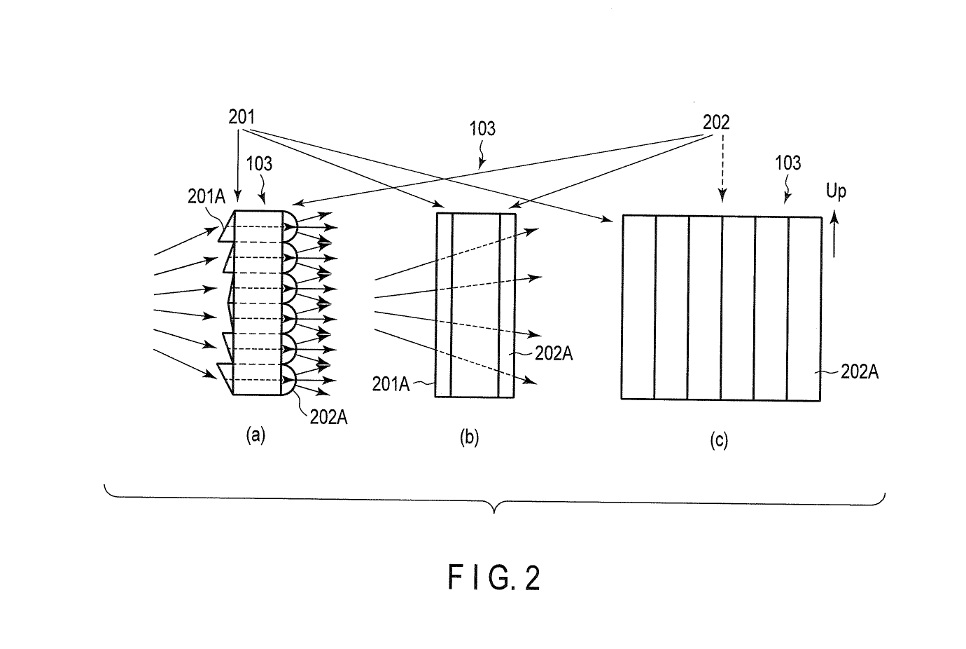

FIG. 2 is a plan view and side view schematically showing the structure of the integrated lens 103 in the horizontal and vertical fields of view. (c) of FIG. 2 is a rear view showing the planar shape of the integrated lens 103 when viewed from the image projector 101. In the integrated lens 103, a cylindrical Fresnel lens 201 which collimates projection rays in the horizontal field of view is arranged on the rear side on which rays emitted by the image projector 101 enter. A lenticular lens 202 which separates rays by angle in accordance with parallaxes, that is, directs rays in directions (directions specified by parallax numbers) corresponding to the parallaxes of parallax image components is formed on a side on which rays emerge toward the diffusion plate 104. The cylindrical Fresnel lens 201 and lenticular lens 202 are integrated as the integrated lens 103. The cylindrical Fresnel lens 201 is formed from a plurality of prism elements 201A arranged in the horizontal direction. Each prism element 201A extends in the vertical direction perpendicular to the horizontal plane. Parallax image components contained in the projection image are refracted to be parallel through the prism elements 201A in the horizontal field of view, and are directed to the lenticular lens 202.

In the cylindrical Fresnel lens 201, a boundary is generated between the adjacent prism elements 201A. As will be described later, the boundary is defined as an ineffective area. A prism area between these boundaries (ineffective areas) serves as an effective area where a ray containing a parallax image component is refracted. The lenticular lens 202 is formed from a plurality of cylindrical lens elements 202A arranged in the horizontal direction. Each cylindrical lens element 202A extends in the vertical direction, and sends a parallax image component in a direction determined for each parallax image component. Similarly, a boundary is generated between the adjacent cylindrical lens elements 202A. This boundary is also defined as an ineffective area. The surface of the lens element 202A between these ineffective areas is defined as an effective area where directivity is imparted to a ray containing a parallax image component.

Parallax image components are distributed to pixels in the display apparatus in which the image projector 101 generates an image. Hence, the ineffective area corresponds to the boundary between pixels of a projected image, or one pixel or some adjacent pixels serving as ineffective pixels containing the pixel boundary and containing no parallax image component. When a non-display area such as a black stripe is formed between pixels and projected as an image, it is projected as the boundary between pixels onto the ineffective area.

In the above-described optical system, according to the II (Integral Imaging) method, a plurality of parallax image components extracted from parallax images having the same parallax number are projected forward from the different cylindrical lens elements 202A. A plurality of parallax image components extracted from different parallax images allow the viewer to view a 3D image capable of stereopsis with his naked eye.

In the cylindrical Fresnel lens 201, straight steps are generated as ineffective areas between the prism elements 201A, and extend in the vertical direction. Similarly, in the lenticular lens 202, straight boundaries are generated between the cylindrical lens elements 202A and extend as ineffective areas in the vertical direction. The prism elements 201A and cylindrical lens elements 202A are formed so that the straight step between the prism elements 201A substantially coincides with the boundary between the cylindrical lens elements 202A in the direction in which collimated rays travel. In other words, the prism elements 201A and cylindrical lens elements 202A are arrayed in the horizontal direction by giving a step pitch and boundary pitch of the same value so that their ineffective areas transparently overlap each other in the horizontal direction, as indicated by broken lines in (a) of FIG. 2. Here, the boundaries of parallax image components formed from a plurality of pixels are defined as the boundaries of the prism elements 201A and cylindrical lens elements 202A. Thus, the step pitch and boundary pitch are set to be an integer multiple of the pixel pitch of a pixel forming a projection image. The integrated lens 103 shown in FIG. 2 is fabricated by, e.g., molding a resin for an optical element such as PMMA or PC at once for both the front and back surfaces.

A projection image to be projected to the integrated lens is created in consideration of parallax separation in the lenticular lens 202. The projection image is created so that, when rays forming parallax image components enter the lenticular lens 202, they enter only the effective areas of the prism elements 201A of the cylindrical Fresnel lens 201 and do not enter the boundaries between the prism elements 201A. In other words, the projection image is generated in advance as follows. The boundaries between the prism elements 201A of the cylindrical Fresnel lens 201 are defined as ineffective areas. The boundary areas between the groups of a plurality of parallax image components entering the prism elements 201A of the cylindrical Fresnel lens 201 are projected to these boundaries. Thus, rays of the parallax image components substantially enter the effective areas of the prism elements 201A of the cylindrical Fresnel lens 201 and are not projected to boundaries corresponding to the ineffective areas between the effective areas. This is because rays of parallax image components cannot accurately be separated by angle and emerge at the boundaries between the prism elements 201A of the cylindrical Fresnel lens 201. The projection image is therefore formed so that, even if there are steps which are formed between the prism elements 201A to coincide with the boundaries between the prism elements 201A of the cylindrical Fresnel lens 201, rays forming parallax image components do not enter the steps across them, and enter the prism elements 201A. Since rays forming parallax image components enter the prism elements 201A of the cylindrical Fresnel lens 201 without entering the steps, degradation of the image quality of parallax images projected forward can be prevented.

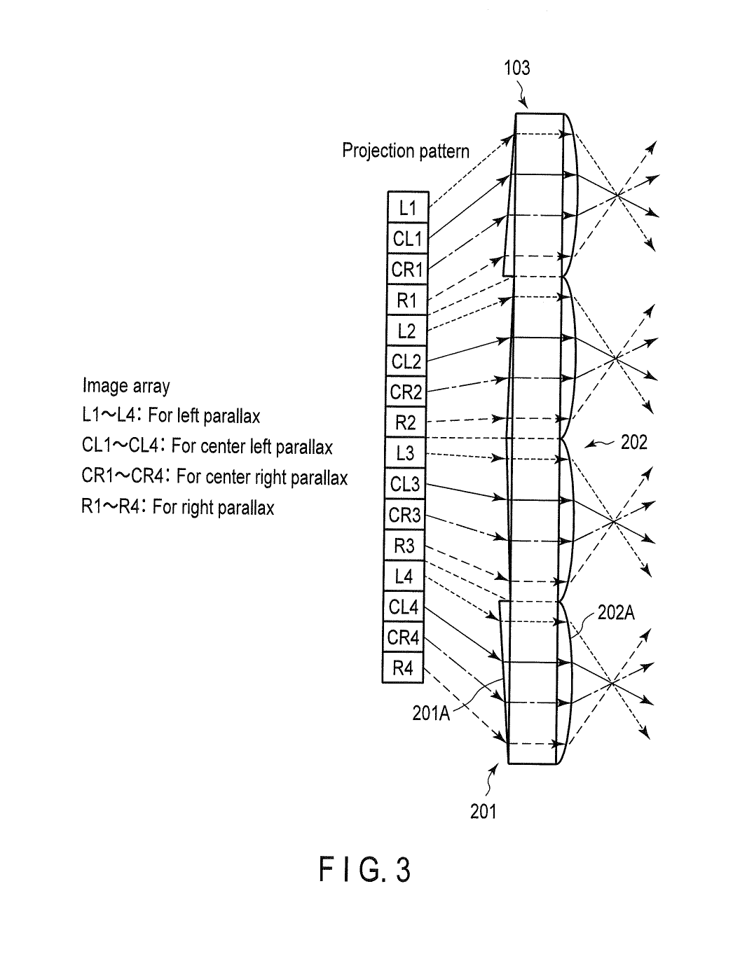

The relationship between the projection pixel and the lenticular lens 202 will be explained in more detail with reference to FIG. 3. FIG. 3 schematically shows the structure of the integrated lens 103 in the horizontal field of view. In the structure example shown in FIG. 3, the width of four pixels arrayed in the horizontal direction coincides with the pitch of the cylindrical lens element 202A of the lenticular lens 202. In FIG. 3, pixels to be projected correspond to parallax image components, and are denoted by signs L1, CL1, CR1, R1, L2, CL2, . . . , CR4, and R4. A pattern of pixels arrayed in this sign order is projected onto the effective area of the cylindrical Fresnel lens 201, collimated by the cylindrical Fresnel lens 201, and enters the lenticular lens 202. The pixels corresponding to the parallax image components are deflected by the respective cylindrical lens elements 202A in corresponding directions. The four pixels L1, CL1, CR1, and R1, the four pixels L2, CL2, CR2, and R2, the four pixels L3, CL3, CR3, and R3, and the four pixels L4, CL4, CR4, and R4 are grouped. The pixel pattern is projected to the cylindrical Fresnel lens 201 so that the boundaries between the first to fourth pixel groups coincide with the steps between the prism elements 201A, respectively.

As shown in FIG. 3, projection rays of the pixels L1 to L4 corresponding to parallax image components are refracted by the different prism elements 201A, collimated, and enter the different lens elements 202A almost parallelly to each other. Then, the rays are directed in the left direction when viewed from the viewer 2, and are projected on the side of the viewer 2. Similarly, projection rays of the pixels CL1 to CL4 corresponding to parallax image components are refracted by the different prism elements 201A, collimated, and enter the different lens elements 202A almost parallelly to each other. Then, the rays are directed in the center-left direction when viewed from the viewer 2, and are projected on the side of the viewer 2. Projection rays of the pixels CR1 to CR4 corresponding to parallax image components are refracted by the different prism elements 201A, collimated, and enter the different lens elements 202A almost parallelly to each other. Then, the rays are directed in the center-right direction when viewed from the viewer 2, and are projected on the side of the viewer 2. Projection rays of the pixels R1 to R4 corresponding to parallax image components are refracted by the different prism elements 201A, collimated, and enter the different lens elements 202A almost parallelly to each other. Then, the rays are directed in the right direction when viewed from the viewer 2, and are projected on the side of the viewer 2.

The pixels L1 to L4 corresponding to left parallax image components are created by extracting them from a left parallax image L captured by a given camera. Similarly, the pixels CL1 to CL4 corresponding to center-left parallax image components, the pixels CR1 to CR4 corresponding to center-right parallax image components, and the pixels R1 to R4 corresponding to right parallax image components are created by extracting them from a center-left parallax image CL captured by a given camera, a center-right parallax image CR captured by a given camera, and a right parallax image R captured by a given camera, respectively. These sliced pixels are arrayed in a pattern as shown in FIG. 3 to create images, and the images arrayed in the pattern are projected to the integrated lens 103.

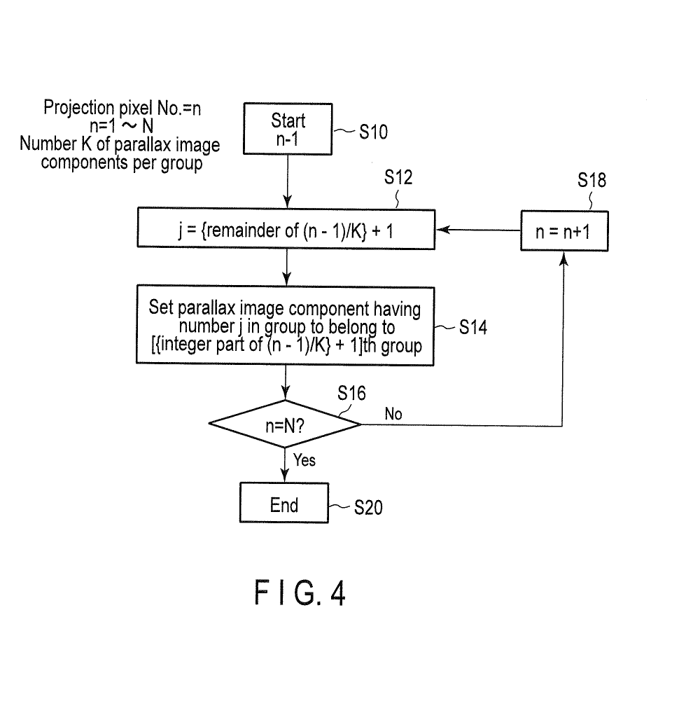

A process to create the projection image will be explained with reference to the flowchart of FIG. 4.

When capturing images for stereopsis, m cameras are prepared in accordance with the parallax count m and capture an object. As a result, m parallax images corresponding to the parallax count m are prepared. The same parallax number is assigned to parallax images in correspondence with the camera number. K parallax image components (parallax image segments) are extracted from each parallax image and distributed to an image pattern formed from a plurality of groups. As described above, it is set that the respective groups correspond to the prism elements 201A, the respective group patterns are projected to the corresponding prism elements 201A, and the boundaries between the group patterns are projected to the steps between the prism elements 201A.

In the image pattern (projection image) shown in FIG. 3, four (m=4) parallax images L, CL, CR, and R are prepared. Four (K=4) parallax image components (parallax image segments) are extracted from one parallax image (L, CL, CR, or R) and distributed to the image pattern of four groups (each group will be called an element image). The first to Nth parallax image components are created based on the m parallax images. The first to Nth parallax image components are arrayed as an image pattern (projection image), and projected to the cylindrical Fresnel lens 201.

In the image pattern (projection image) shown in FIG. 3, 16, first to 16th (N=16) parallax image components (16 pixel segments) are created based on four (m=4) parallax images. The first to 16th parallax image components are arrayed in a predetermined image pattern (projection image), and projected to the cylindrical Fresnel lens 201. The image pattern (projection image) shown in FIG. 3 is formed from the first to fourth group patterns (first to fourth element images). Four (m=4) parallax images Li, CLi, Ci, and Ri are successively distributed to each of the first to fourth group patterns, determining an array of the 16, first to 16th (N=16) parallax image components, as shown in FIG. 4.

Parallax image components extracted from parallax images are distributed based on a viewing area where a viewer set in capturing is capable of stereopsis, and a viewing area reference plane for setting the viewing area. Each distributed parallax image component belongs to one group (element image), and its array position in the group (element image) is classified according to a sequence shown in FIG. 4.

When the created projection image pattern is continuously input, analysis of the position of each parallax image component and a group to which the parallax image component belongs starts in step S10 shown in FIG. 4. In step S12, the position of each parallax image component in the group is determined by j={remainder of (n−1)/K}+1. K is the number of parallax image components forming a group (element image), and is equal to the parallax count m. In the example shown in FIG. 3, K=4 and N=16. In the pattern as shown in FIG. 3, for example, the first (n=1) parallax image component of the image pattern (projection image) is n=1. Thus, {remainder of (n−1)/K} is 0, and the number j in a given group: j={remainder of (n−1)/K}+1 is 1 (=j). It is determined that the parallax image component is arrayed at the first position in a given group. Then, in step S14, a group (element image) to which each parallax image component belongs is determined from an expression of [{integer part of (n−1)/K}+1]. For example, the first (n=1) parallax image component of the image pattern (projection image) is n=1. Hence, {integer part of (n−1)/K} is 0, and [{integer part of (n−1)/K}+1] is “+1”. From this, it is determined that the given group is the first group (first element image). In the image pattern (projection image) shown in FIG. 3, the first (n=1) parallax image component L1 is determined to be arrayed at the first (=j) position in the first group (first element image), and is stored in the memory.

In step S16, it is checked whether n has reached a maximum value N. If n has not reached the maximum value N, n is incremented by one in step S18, and the process returns to step S12. In step S12, j (={remainder of (n−1)/K}+1) is calculated again. In the example shown in FIG. 3, the second (n=2) parallax image component of the image pattern (projection image) is n=2. Thus, {remainder of (n−1)/K} is 1, and the number j in a given group is 2. In step S14, a group (element image) to which each parallax image component belongs is determined from the expression of [{integer part of (n−1)/K}+1]. In the example shown in FIG. 3, the second (n=2) parallax image component of the image pattern (projection image) is n=2. Hence, {integer part of (n−1)/K} is “0”, and [{integer part of (n−1)/K}+1] is “+1”. It is therefore determined that the given group is the first group (first element image). The second (n=2) parallax image component CL1 of the image pattern (projection image) shown in FIG. 3 is determined to be arrayed at the second (=j) position in the first group (first element image), and is stored in the memory.

Steps S12 to S18 are repeated in the same way. For example, the third (n=3) parallax image component CL1 of the image pattern (projection image) shown in FIG. 3 is determined to be arrayed at the third (=j) position in the first group (first element image), and is stored in the memory. The fourth (n=4) parallax image component CL1 of the image pattern (projection image) shown in FIG. 3 is determined to be arrayed at the fourth (=j) position in the first group (first element image), and is stored in the memory.

In step S12, if (n−1) exceeds K, for example, n=5, j=1 is obtained from j (={remainder of (n−1)/K}+1), and it is revealed by analysis that the parallax image component is arrayed at the first position in a given group. Then, in step S14, it is analyzed from [{integer part of (n−1)/K}+1] that the given group is the second group. For example, for n=6, steps S12 to S18 are repeated in the same way, and it is revealed by analysis that a parallax image component corresponding to n=6 is arrayed at the second position in the second group.

Steps S12 to S18 are repeated until n reaches the maximum number N. If n reaches the maximum number N, the process ends in step S20, and the positions and groups of the respective parallax image components of the projection image pattern as shown in FIG. 3 are analyzed and stored in the memory.

In the projection image pattern shown in FIG. 3, the cylindrical lens boundaries on the lenticular lens surface are set at the boundaries between pixels to be projected. Hence, the steps on the cylindrical Fresnel lens surface that are formed to coincide with the boundary positions are also set at the boundaries between pixels to be projected. As long as projection light is split for the respective pixels and enters the cylindrical Fresnel lens without entering the steps serving as the boundaries, the image quality of formed parallax images does not degrade. Even if projection rays of the respective pixels have a small positional error or slightly diverge, degradation of the image quality of parallax images at the steps is little.

As described above, the position of the step of the cylindrical Fresnel lens and that of the boundary of the lenticular lens need to accurately coincide with each other. In the integrated lens according to the embodiment, the cylindrical Fresnel lens and lenticular lens are fabricated with their positions aligned from the beginning. Compared to a case in which two separate lenses are used, this integrated lens is advantageous in cost because the number of components is decreased simply, and also in the simplification of handling and improvement of the reliability of the overall apparatus because alignment is unnecessary in attachment to the apparatus.

### Second Embodiment

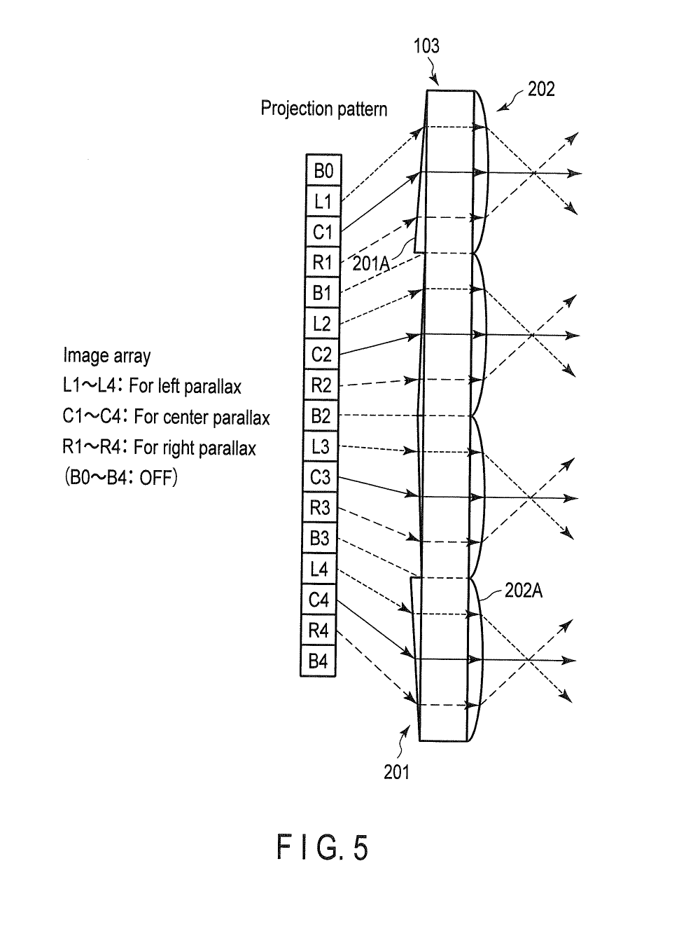

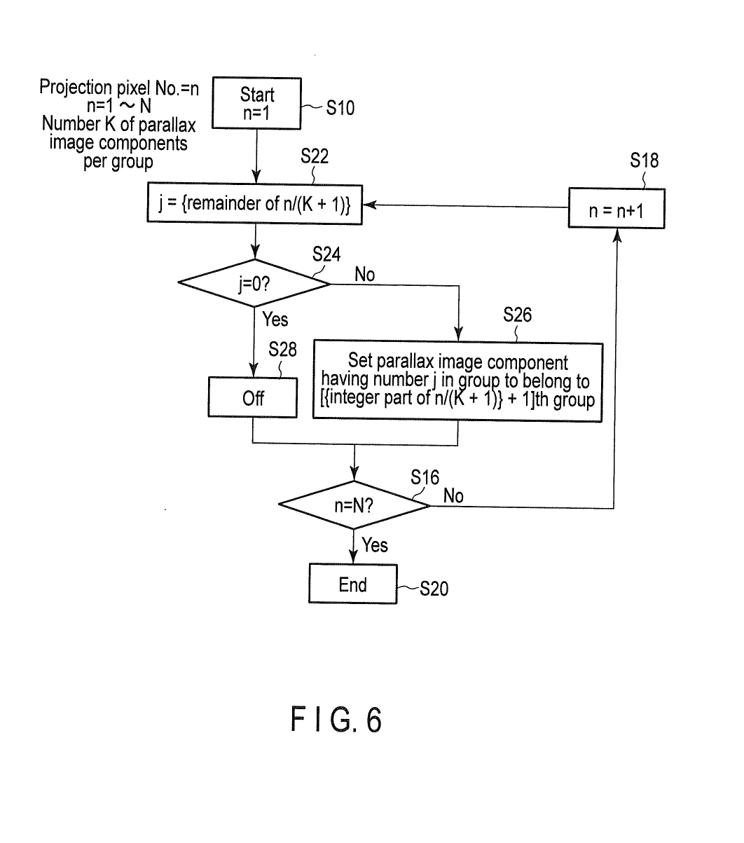

As the second embodiment, a projection image pattern as shown in FIG. 5 may be formed instead of the pattern shown in FIG. 3. The projection image pattern shown in FIG. 5 is created through a process shown in the flowchart of FIG. 6.

In the projection image pattern shown in FIG. 5, four pixels in the horizontal field of view coincide with the pitch of a cylindrical lens element 202A on a lenticular lens 202, similar to the pattern shown in FIG. 3. In the projection image pattern shown in FIG. 5, unlike the pattern shown in FIG. 3, an image (projection pixel) B0 is arranged at the start of the group of the parallax image components L1, C1, and R1. Also, an image (projection pixel) B1 is arranged between the group of the parallax image components L1, C1, and R1 and the group of the parallax image components L2, C2, and R2. An image (projection pixel) B2 is arranged between the group of the parallax image components L2, C2, and R2 and the group of the parallax image components L3, C3, and R3. Similarly, images (projection pixels) B3 and B4 are arranged between the groups of parallax image components. Similar to the pattern shown in FIG. 3, the pixels L1 to L4 correspond to left parallax image components, the pixels C1 to C4 correspond to center parallax image components, and the pixels R1 to R4 correspond to right parallax image components. When the display apparatus displays an image, projection rays (black projection images when projection rays have no brightness at all) containing the pixels B0 to B4 each inserted in every three parallax image components (projection pixels) are directed to the boundaries between the cylindrical lens elements 202A on the surface of the lenticular lens 202. The pixels B0 to B4 have substantially no brightness, and serve as black band-like pixels (OFF pixels) to form projection images (OFF images) at the boundaries between the cylindrical lens elements 202A. Therefore, a projection image is formed so that essentially no rays forming parallax image components enter the steps, and enter prism elements without entering the steps. This can prevent degradation of the image quality of formed projection images.

In the projection image pattern shown in FIG. 5, three (m=3) parallax images; L, C, and R are prepared. Three (K=3) parallax image components (pixels or pixel sets) are extracted from one parallax image (L, C, or R) and distributed to the image pattern of four groups. Component images (projection pixels) having no brightness are arranged on the two sides of the projection parallax image components (projection pixels) Li, Ci, and Ri having brightness. The projection image pattern is formed by repeating an image group of the projection parallax image components (projection pixels) Li, Ci, and Ri having brightness and the component image (projection pixel) Bi having no brightness. The projection image pattern shown in FIG. 5 is formed from the first to fourth image groups. As described above, parallax image components extracted from parallax images are distributed based on the viewing area and viewing area reference plane. The projection parallax image components (projection pixels) Li, Ci, and Ri, and the component image (projection pixel) Bi having no brightness are input sequentially. Each distributed parallax image component belongs to one group (element image), and its array position in the group (element image) is classified according to a sequence shown in FIG. 6.

In the flowchart shown in FIG. 6, the same reference numerals as those shown in FIG. 4 denote the same steps, and a description thereof will be omitted. In the array of the projection image pattern shown in FIG. 5, the first image pattern (projection image: n=0) is set to be the OFF image (black band-like pixel) B0. The first OFF image (black band-like pixel) B0 is set as the 0th image.

When the projection image pattern is continuously input, analysis of the position of each parallax image component and a group to which the parallax image component belongs starts in step S10 shown in FIG. 6. In step S22, the position of each parallax image component in the group is determined by j={remainder of n/(K+1)}+1. K is the number of parallax image components forming a group (element image), and is equal to the parallax count m. In the example shown in FIG. 5, K=3 and N=16. In the pattern as shown in FIG. 5, for example, the first (n=1) parallax image component of the image pattern (projection image) is n=1. Thus, {remainder of n/(K+1)} is 0, and the number j in a given group: j={remainder of n/(K+1)}+1 is 1 (=j). It is therefore determined that the parallax image component is arrayed at the first position in a given group. Then, in step S24, j≠0. In step S26, a group (element image) to which each parallax image component belongs is determined from an expression of [{integer part of n/(K+1)}+1]. For example, the first (n=1) parallax image component of the image pattern (projection image) is n=1. Hence, {integer part of n/(K+1)} is 0, and [{integer part of n/(K+1)}+1] is “+1”. From this, it is determined that the given group is the first group (first element image). In the image pattern (projection image) shown in FIG. 5, the first (n=1) parallax image component L1 is determined to be arrayed at the first (=j) position in the first group (first element image), and is stored in the memory.

The process returns again to step S22 after steps S16 and S18. In step S22, j=2 is obtained from j={remainder of n/(K+1)}. In step S12, it is determined that the given group is the first group (first element image), and it is revealed by analysis that the parallax image component is arrayed at the second (j=2) position in the first group (first element image).

In step S22, if n reaches (K+1), the remainder in step S22 becomes 0. It is therefore determined in step S24 that j=0, and the process advances to step S28. The fourth (n=4) parallax image component of the image pattern (projection image) is determined to be the OFF image B1 (black band-like pixel) succeeding the first group. The OFF image B1 (black band-like pixel) is given and stored in the memory.

After that, n becomes 5. In step S22, the remainder becomes 1 again. In step S24, j≠0, and the parallax image component is determined to be an ON image (parallax image component). The process then advances to step S26. In step S26, [{integer part of n/(K+1)}]=1. Hence, it is determined that the given group is the second group and that the parallax image component corresponding to n=5 is arrayed at the first position (j=1) in the second group.

n becomes 6 after steps S16 and S18, and the process returns again to step S22. In step S22, j (=[{remainder of n/(K+1)}]) is calculated to be 2. In step S24, j≠0, and the parallax image component is determined to be an ON image (parallax image component). Then, the process advances to step S26. In step S26, [{integer part of n/(K+1)}]=1. Thus, it is determined that the given group is the second group and that the parallax image component corresponding to n=6 is arrayed at the second position (j=2) in the second group.

As described above, the pixels of the projection image are arrayed as pixels forming the first to Kth parallax image components for the parallax count K. The (K+1)th pixel does not contribute to parallax and is a no-display (OFF) pixel having no brightness. This array is repeated, determining the projection image pattern. As shown in FIG. 5, non-display (OFF) pixels are arranged in the image pattern so that light traveling from the pixel is not projected to the boundary portion between prism elements 201A of a cylindrical Fresnel lens 201, in other words, a pixel having no brightness is projected. For this reason, no ray is projected to the steps of the cylindrical Fresnel lens 201 that are formed to coincide with the boundary positions. In the optical system shown in FIG. 5, compared to the one shown in FIG. 3, the parallax count is decreased by one under the same projection conditions, but a non-projection area of one pixel width is set instead, slightly decreasing the use efficiency of projection pixels. However, even if projection rays for the respective pixels have a small positional error or slightly diverge, they can enter the prism elements 201A without entering the steps. Degradation of the image quality of parallax images at the steps can be prevented.

Even in the optical system shown in FIG. 5, the position of the step of the cylindrical Fresnel lens 201A and that of the boundary between the cylindrical lens elements 202A need to accurately coincide with each other. In an integrated lens 103, the cylindrical Fresnel lens and lenticular lens are fabricated with their positions aligned from the beginning. Compared to a case in which two separate lenses are used, the integrated lens 103 is advantageous in cost simply because the number of components is decreased, and also in the simplification of handling and improvement of the reliability of the overall apparatus because alignment is unnecessary in attachment to the apparatus.

### Third Embodiment

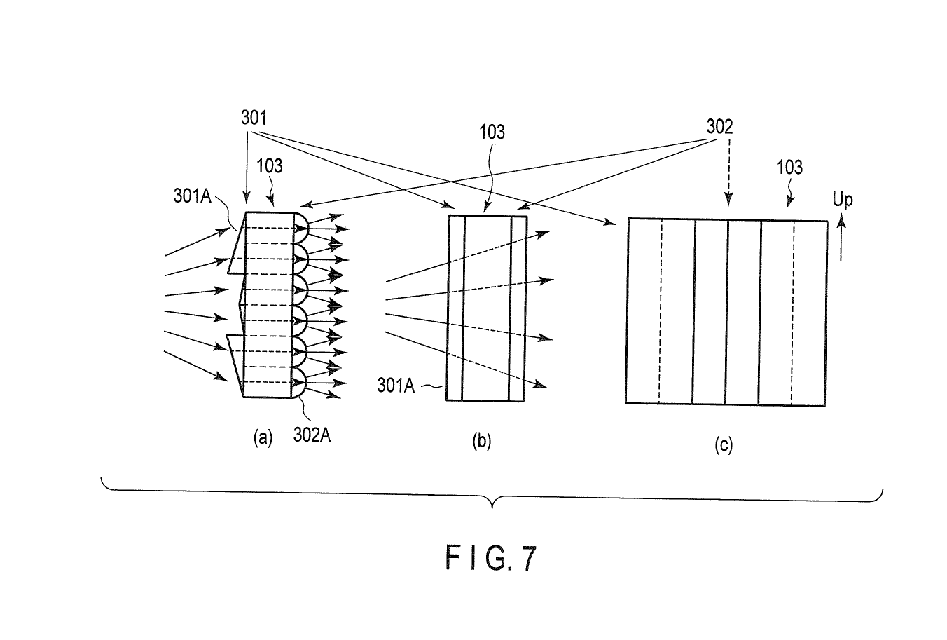

The third embodiment will be explained with reference to FIG. 7.

As is apparent from a comparison between FIG. 2 and FIG. 7, an optical system according to the third embodiment is different in the structure of an integrated lens 103 from the optical system according to the first embodiment. In the integrated lens 103 according to the first embodiment, the step pitch of the prism element 201A of the cylindrical Fresnel lens 201 coincides with the pitch of the cylindrical lens element 202A of the lenticular lens 202. However, as long as the step position and the boundary position between the cylindrical lens elements 202A correspond to each other, the image quality of parallax images does not degrade. The step serving as an ineffective area between prism elements 301A of a cylindrical Fresnel lens 201 need not always correspond to the boundary serving as an ineffective area between cylindrical lens elements 302A of a lenticular lens 202. As shown in FIG. 7, the number of steps may be decreased so that the pitch of the step between the prism elements 301A becomes an integer multiple of the pitch of the cylindrical lens element 302A.

### Fourth Embodiment

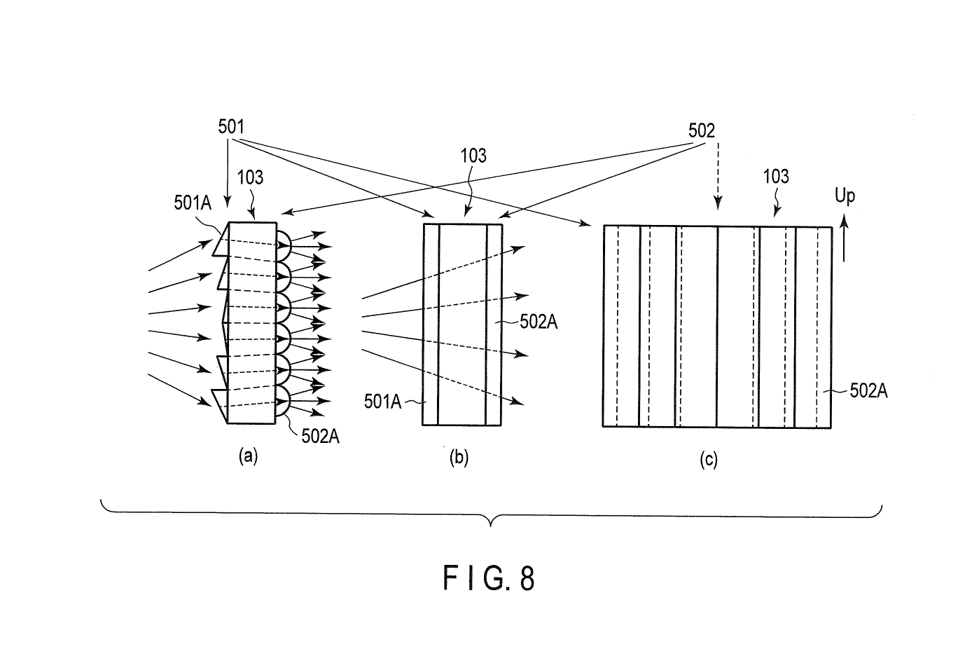

The fourth embodiment will be explained with reference to FIG. 8.

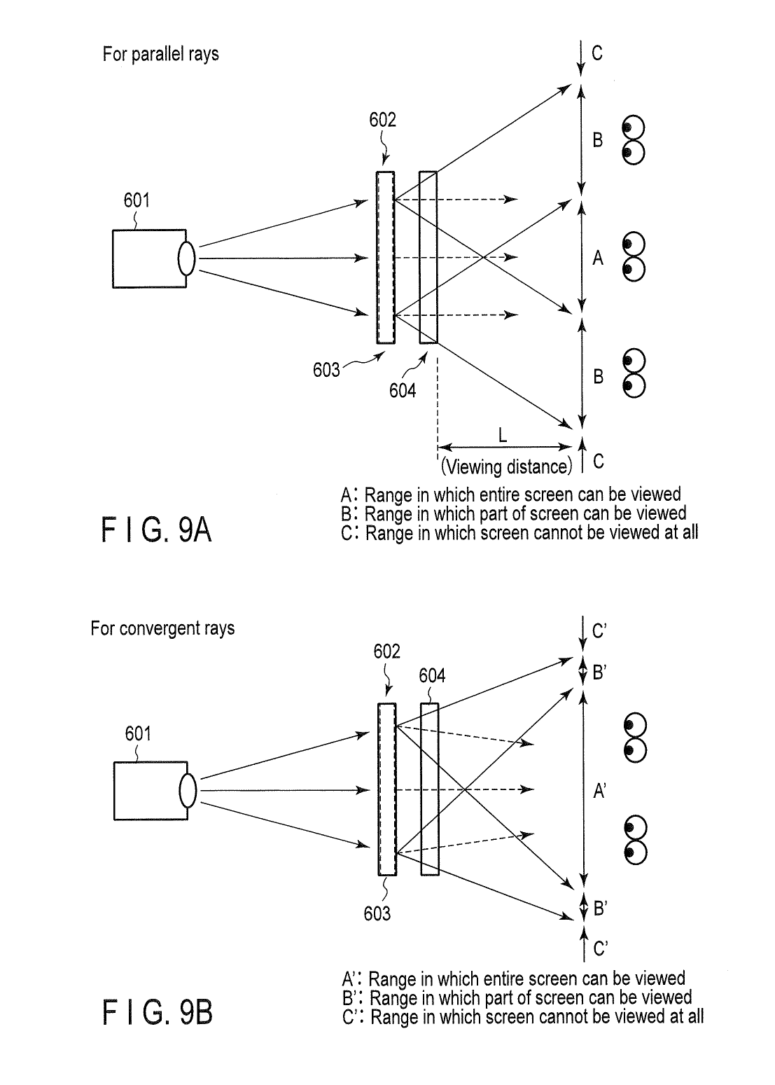

In the optical system according to the first embodiment, the integrated lens 103 collimates projection rays through the cylindrical Fresnel lens 201 on the incident side. For this purpose, the step pitch of the prism element 201A is designed to coincide with the pitch of the cylindrical lens element 202A of the lenticular lens 202 on the exit side. In an optical system according to the fourth embodiment, unlike the first embodiment, an integrated lens 103 does not collimate projection rays through a cylindrical Fresnel lens 501 on the incident side, but refracts them through the cylindrical Fresnel lens 501 and converges them in the horizontal field of view. The direction of a ray from a parallax image is controlled so that a ray converged by changing the ray angle enters a lenticular lens 502 on the exit side. Ray traces in an embodiment in which projection rays are converged and an embodiment in which they are collimated will be explained by comparison in FIGS. 9A and 9B.

FIG. 9A is a plan view showing an optical system which collimates rays, and FIG. 9B is a plan view showing an optical system which converges rays. These two plan views show deflection ranges of projection rays in the horizontal field of view in which the direction can be changed by the lenticular lens of an integrated lens 603. The traces of rays entering the integrated lens 603 of an image display unit 602 from an image projector 601 are the same in FIGS. 9A and 9B. In FIG. 9A, parallel rays enter the lenticular lens on the exit side of the integrated lens 603. In this optical system, rays emerge from all positions on the screen within the same deflection angle range, and an image is viewed via a diffusion plate 604. When the screen is viewed at a given viewing distance L, a range A in which the entire screen can be viewed, a range B in which only part of the screen can be viewed, and a range C in which the screen cannot be viewed at all are generated. In FIG. 9B, convergent rays enter the lenticular lens on the exit side in the integrated lens 603, and the deflection angle range of an emerging ray changes depending on the position on the screen. When the screen is viewed at the viewing distance L, a range A′ in which the entire screen can be viewed, a range B′ in which only part of the screen can be viewed, and a range C′ in which the screen cannot be viewed at all are generated, too. However, from a comparison between FIGS. 9A and 9B, the range A<the range A′ holds. That is, the range where the entire screen can be viewed can be set to be wider in the optical system which converges projection rays, compared to the optical system which collimates projection rays. In the integrated lens 103 shown in FIG. 8 which converts projection rays into convergent rays, a correspondence considering the angles of convergent rays is set up between the step positions of a cylindrical Fresnel lens 501 and the boundary positions between cylindrical lens elements 502A of a lenticular lens 502. More specifically, the step pitch is reduced at a reduction magnification determined by the angle of a convergent ray. Then, the lens pitch of the lens element 502A is determined, and the boundary position between the cylindrical lens elements 502A is determined. The pitch of a prism element 501A of the cylindrical Fresnel lens 501 and that of the cylindrical lens element 502A of the lenticular lens 502 do not coincide with each other. However, in the fourth embodiment, as well as the first embodiment, rays forming parallax images enter the cylindrical Fresnel lens without entering the steps of the cylindrical Fresnel lens.

Note that the fourth embodiment employs the optical system which converges projection rays. However, the optical system is not limited to this, and the structure of an integrated lens can be designed for an optical system which controls a ray to an arbitrary ray angle.

### Fifth Embodiment

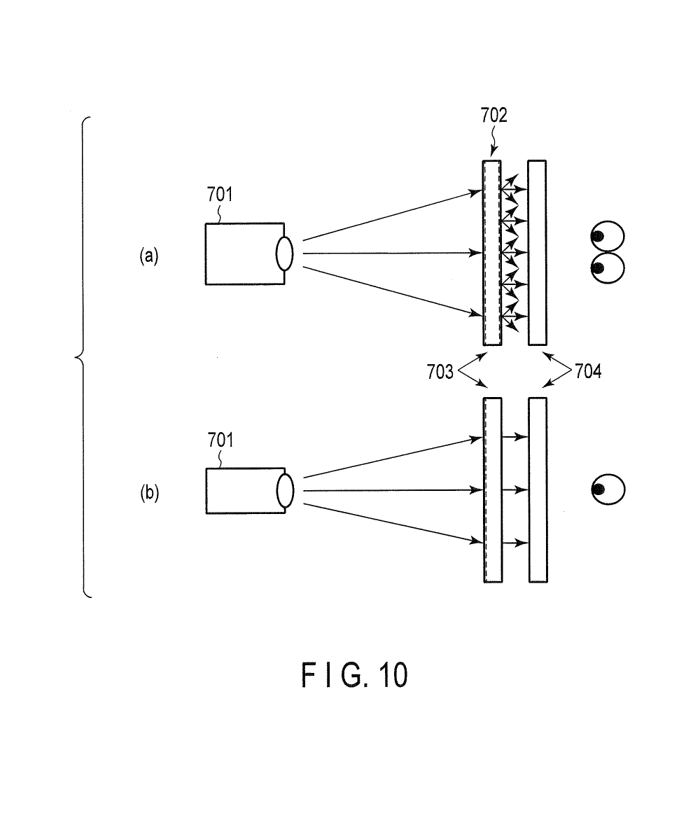

FIG. 10 is views showing the arrangement of an optical system according to the fifth embodiment. Similarly to the first embodiment, a display apparatus includes an image projector 701 and image display unit 702, and the image display unit 702 includes an integrated lens 703 and diffusion plate 704. In the first embodiment shown in FIG. 1, the integrated lens 103 collimates projection rays in the horizontal direction and separates parallax images. However, in the fifth embodiment shown in FIG. 10, the integrated lens 703 similarly collimates projection rays in the horizontal direction and separates parallax images, and also collimates projection rays in the vertical direction (vertical field of view).

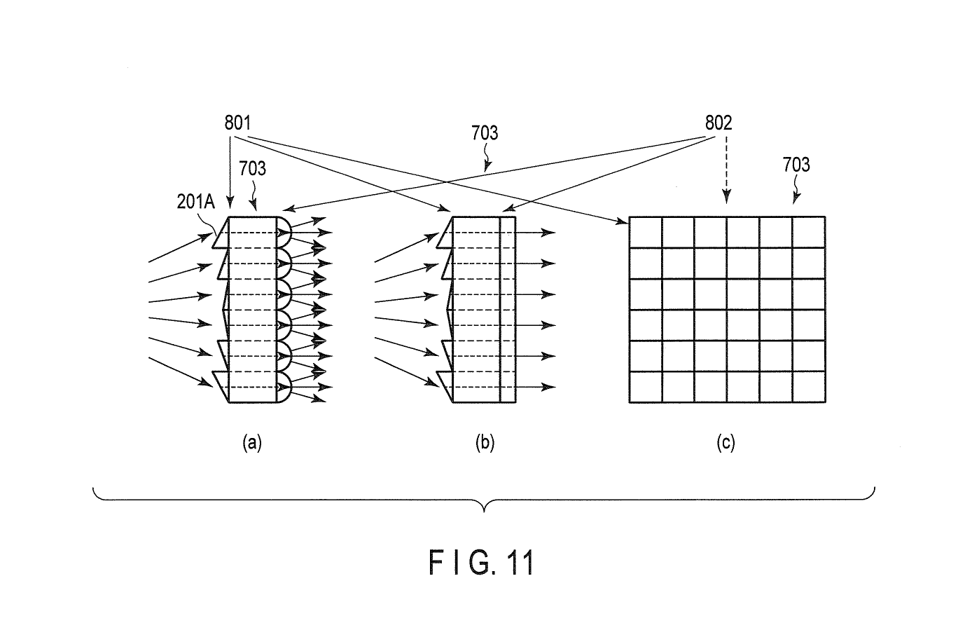

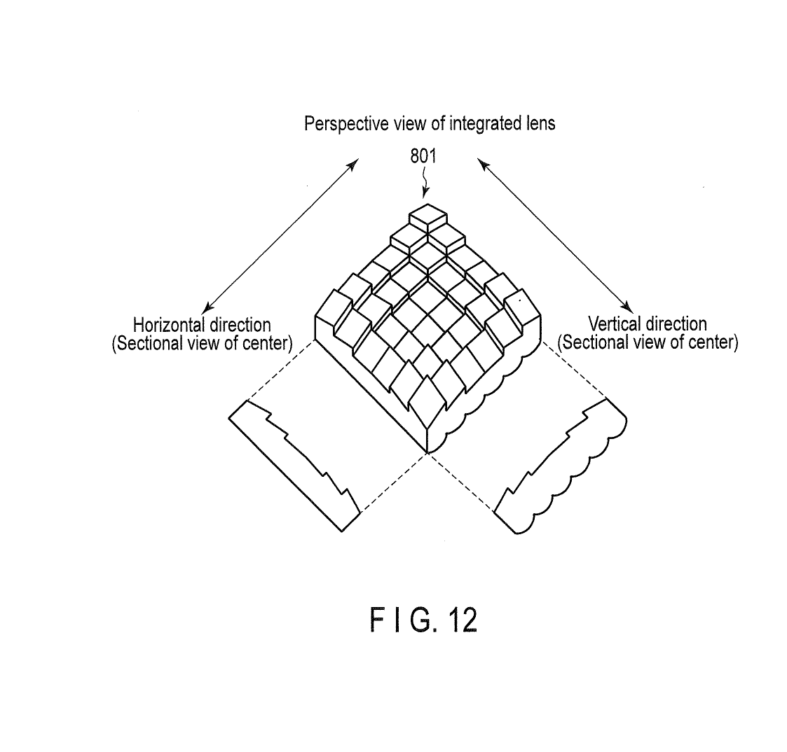

FIG. 11 shows the structure of the integrated lens 703 according to the fifth embodiment. In the integrated lens 103 according to the first embodiment shown in FIG. 2, the cylindrical Fresnel lens 201 on the incident side collimates projection rays in only the horizontal field of view. The step pitch of the cylindrical Fresnel lens 201 coincides with the pitch of the cylindrical lens element of the lenticular lens 202 on the exit side. The integrated lens 703 according to the fifth embodiment is formed as a two-dimensional Fresnel lens 801 having a surface shape shown in the perspective and sectional views of FIG. 12. A general two-dimensional Fresnel lens has concentric steps between prism elements. Conversely, the integrated lens according to the fifth embodiment has straight steps (grating steps) in two perpendicular directions between rectangular prism element arrays, as shown in FIG. 12. Steps in one direction are parallel to the direction of each cylindrical lens element of a lenticular lens 802, similar to the first embodiment. In addition, the step pitch coincides with the pitch of the cylindrical lens element, and the position of the step corresponding to an ineffective area coincides with a boundary position corresponding to an ineffective area between the cylindrical lens elements. A projection image to be projected to the integrated lens 703 is created so that the boundary position of the cylindrical lens element of the lenticular lens 802 coincides with the boundary of a projection pixel or an OFF pixel, as in the above-described embodiments. Also in the fifth embodiment, rays enter the two-dimensional Fresnel lens without entering steps serving as ineffective areas, so degradation of the image quality of projected parallax images can be prevented.

In the optical system according to the fifth embodiment shown in FIG. 11, similarly to the first embodiment, the two-dimensional Fresnel lens collimates projection rays, and the step pitch in the parallax separation direction coincides with the pitch of the cylindrical lens element of the lenticular lens. However, even when projection rays are controlled to an angle other than collimation, similarly to the fourth embodiment, the step in the parallax separation direction is designed to correspond to the boundary position of the cylindrical lens element of the lenticular lens. The other step direction need not always be perpendicular to the direction of each cylindrical lens element of the lenticular lens. Further, the step pitches in the two directions need not coincide with each other.

### Sixth Embodiment

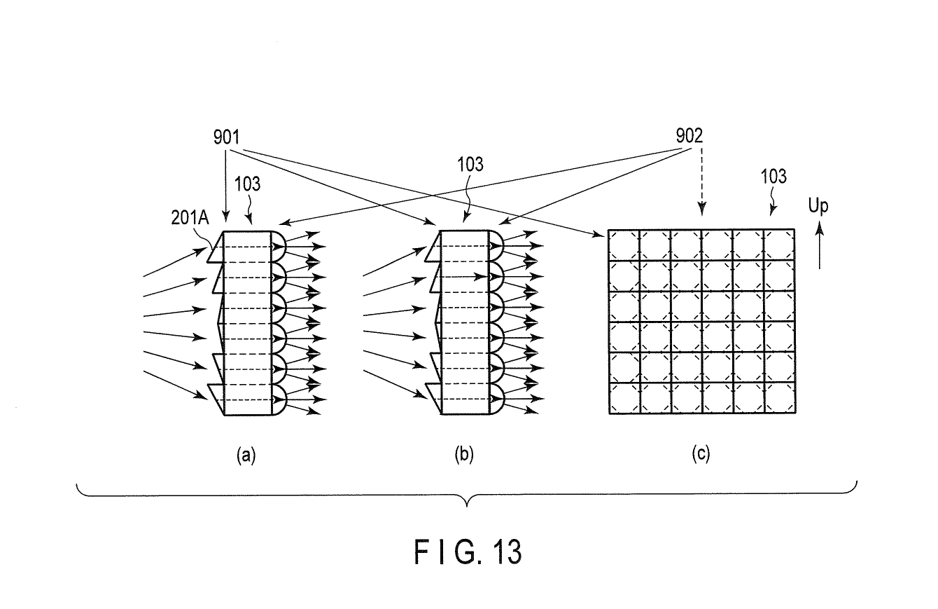

FIG. 13 shows an integrated lens 103 according to the sixth embodiment. A surface of the integrated lens 103 that is opposite to a two-dimensional Fresnel lens 901 shown in FIG. 13 is formed into not a lenticular lens but a two-dimensional lens array 902. In all the various embodiments described above, parallax is imparted in only one direction, e.g., horizontal direction (horizontal field of view). However, the integrated lens 103 shown in FIG. 13 can impart parallax in two perpendicular directions, i.e., horizontal and vertical directions (horizontal and vertical fields of view). Since the lens array 902 deflects projection rays in the two directions, no diffusion plate is used in the arrangement view of the sixth embodiment shown in FIG. 13.

### Seventh Embodiment

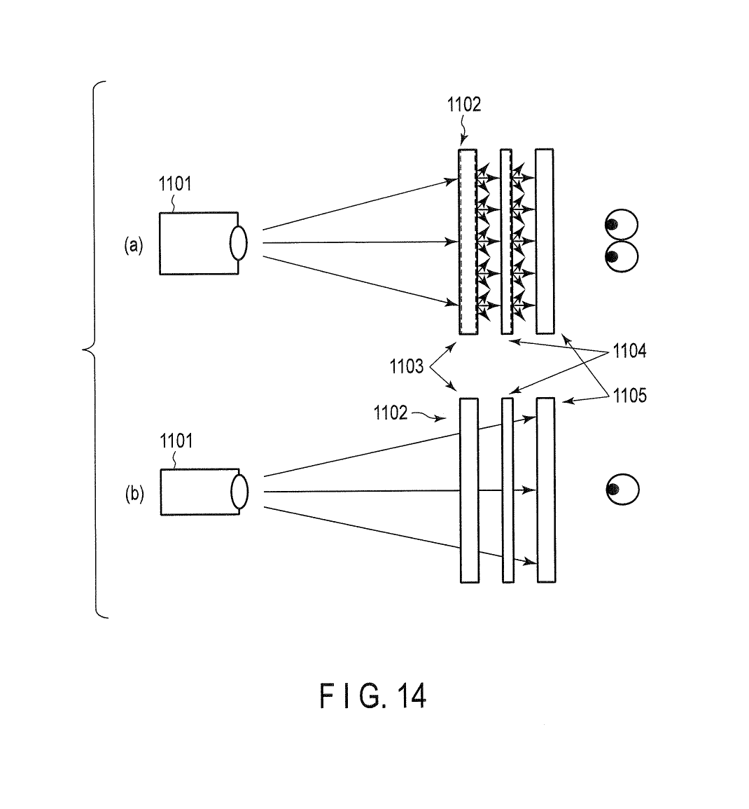

FIG. 14 shows an arrangement according to the seventh embodiment. The above-described embodiments employ one lenticular lens (lenticular lens having only one surface formed into a lenticular lens surface) to generate parallax. In contrast, an image display unit 1102 shown in FIG. 14 adopts an optical system in which two lenticular lenses 1104 are combined. That is, a lenticular lens is arranged as a deflection element in an integrated lens 1103. In addition, a lenticular lens 1104 is interposed as a deflection element between the integrated lens 1103 and a diffusion plate 1105. In this case, the two surfaces of the lenticular lens 1104 may be formed into lenticular surfaces without arranging a lenticular lens on the integrated lens 1103. A combination of two lenticular lenses can implement a larger parallax count and enables parallax separation in which crosstalk is reduced.

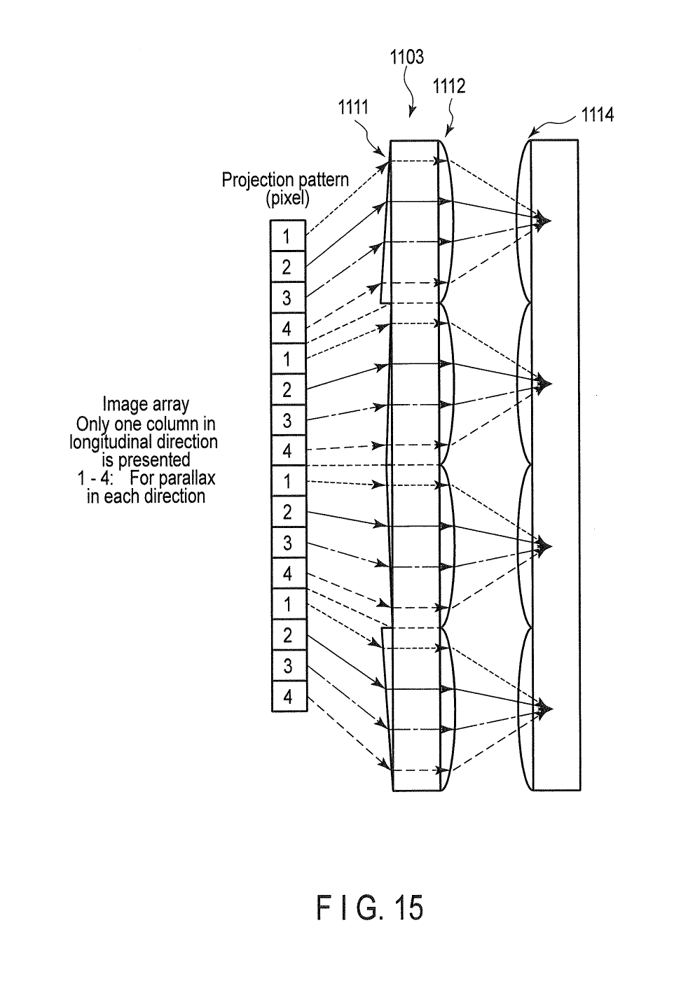

FIG. 15 is an explanatory view showing ray traces in the horizontal parallax plane in the optical system according to the seventh embodiment. As described with reference to FIG. 3, four pixels in the horizontal direction coincide with the pitch of the cylindrical lens element of a first lenticular lens 1112. A pixel boundary corresponding to an ineffective area is projected to coincide with a boundary corresponding to the ineffective area of the cylindrical lens element of a first lenticular lens 1112. In this optical system, a second lenticular lens 1114 is arranged at a position where a ray of each parallax image emerging from a first lenticular lens 1112 converges.

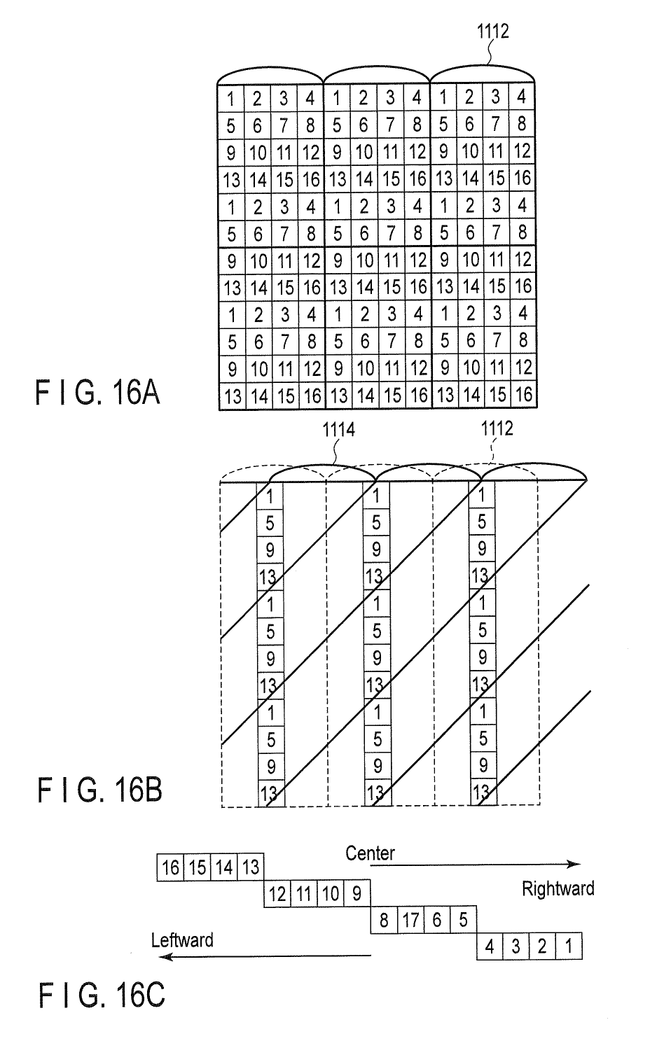

FIG. 16A is an explanatory view showing a plane arrangement in which two-dimensional projection pixels (parallax image components) represented by parallax numbers are projected on the rear surface of the first lenticular lens 1112. FIG. 16B is an explanatory view showing the arrangement relationship between the first lenticular lens 1112 (represented by broken lines) and the second lenticular lens 1114 (represented by solid lines). FIG. 16C is an explanatory view showing the projection direction of two-dimensional projection pixels (parallax image components) emerging from the second lenticular lens 1114 to the front of the viewer.

FIG. 15 shows only a pixel array (parallax image component array) in the horizontal field of view. However, as shown in FIG. 16A, a two-dimensional pixel array (parallax image component array) is projected from a projector 1101 to a display unit 1102. As shown in FIG. 16A, a two-dimensional pixel array (parallax image component array) is projected to the rear surface of the first lenticular lens 1112. In the first lenticular lens 1112, the boundary between the cylindrical lens elements of the lenticular lens 1112 is parallel to the longitudinal direction (vertical direction) of the pixel array (parallax image component array). The pitch (horizontal pitch) is set to be equal to four pixels in the horizontal direction. Hence, as shown in FIG. 16B, the pixel array (parallax image component array) is arranged so that convergent rays of every four pixels in the horizontal parallax direction are aligned in the longitudinal direction at the exit position of the first lenticular lens 1112. In FIG. 16B, for example, “1” is typically added to an area where projection rays of the pixel array (pixels having parallax numbers of 1 to 4) converge. The second lenticular lens 1114 is arranged at the convergence position. The cylindrical lens elements of the second lenticular lens 1114 and their boundaries are inclined by 45° with respect to the first lenticular lens 1112. In the vertical plane, convergent rays enter the second lenticular lens 1114 at 45° with respect to the cylindrical lens elements of the second lenticular lens 1114 and the boundary direction. As a result, the projection rays emerging from the second lenticular lens 1114 are deflected in four directions for longitudinal pixels (pixels in the vertical direction), as shown in FIG. 16C. Further, projection rays of four pixels in the lateral direction (horizontal direction) that have been converged by the first lenticular lens 1112 are distributed and emerge in the deflection directions of the respective longitudinal pixels. That is, parallax images can be displayed in 4×4=16 directions by every four longitudinal pixels and every four lateral pixels in a projected two-dimensional pixel array. Also in this embodiment, the boundary between projection pixels from the image projector 1101 to the image display unit 1102 corresponds to the boundary position between the cylindrical lens elements of the first lenticular lens 1112. Hence, the step between the prism elements of the cylindrical Fresnel lens that is formed to coincide with the boundary position serves as the boundary between pixels to be projected. Degradation of the image quality of parallax images can therefore be prevented.

### Eighth Embodiment

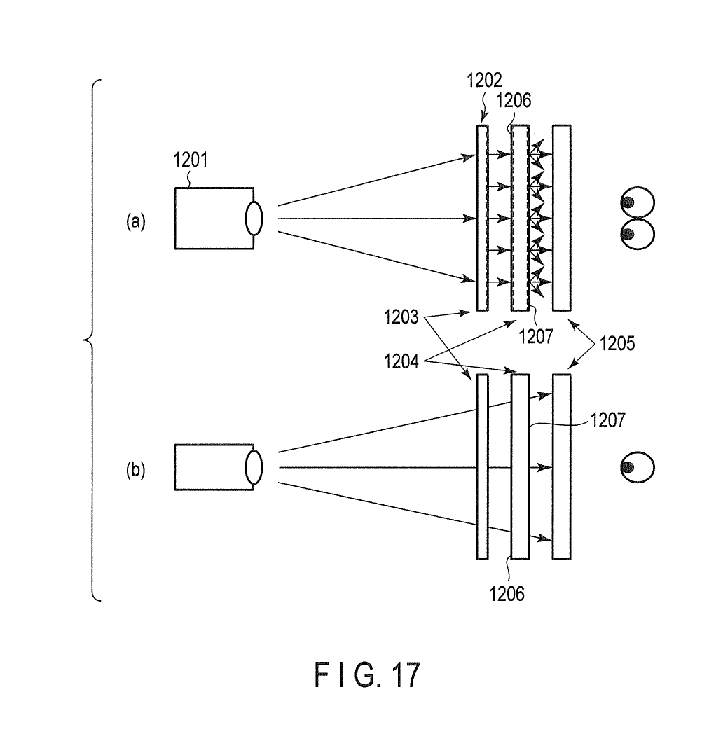

FIG. 17 is views showing the arrangement of an optical system according to the eighth embodiment. Similarly to the seventh embodiment, the eighth embodiment can implement a larger parallax count by combining two lenticular lenses.

As shown in FIG. 17, an image display apparatus includes an image projector 1201 and image display unit 1202. A cylindrical Fresnel lens 1203 of the image display unit 1202 is arranged separately from an integrated lens 1204. In the integrated lens 1204 interposed between the cylindrical Fresnel lens 1203 and a diffusion plate 1205, first and second lenticular lenses 1206 and 1207 are arranged on the incident and exit surfaces of the integrated lens 1204, respectively, implementing a combination of two lenticular lenses (lenticular lens having a two-surface structure).

### Ninth Embodiment

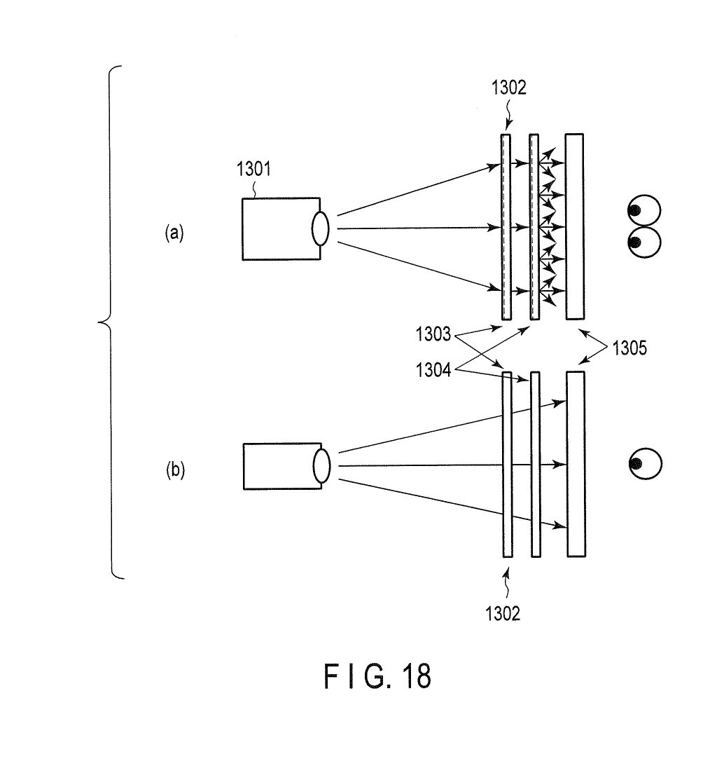

FIG. 18 is views showing the arrangement of an optical system according to the ninth embodiment. The above-described embodiments use an integrated lens. The ninth embodiment implements the function of the integrated lens by using another component, instead of the integrated lens. That is, a cylindrical Fresnel lens 1303 and lenticular lens 1304 may be separate components, as shown in FIG. 18. Needless to say, both stereopsis and high-quality parallax images can be achieved without using the integrated lens. However, the positions of the lenses 1303 and 1304 in the installation state need to be adjusted.

### 10th Embodiment

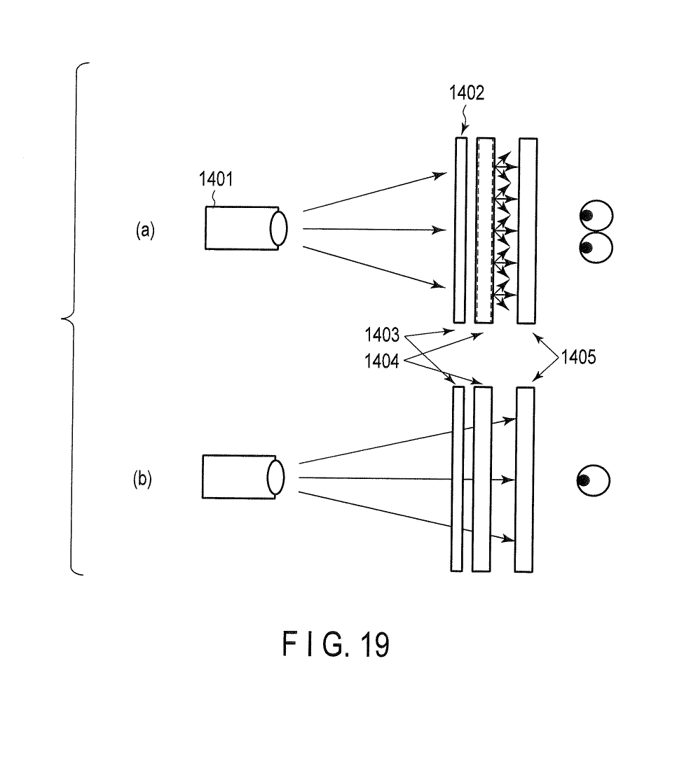

FIG. 19 is views showing the arrangement of an optical system according to the 10th embodiment. In the above-described embodiments, projection rays emitted by the image projector form parallax images. However, in the 10th embodiment, a liquid crystal panel 1403 displays parallax images, and a ray projector 1401 projects projection rays to the liquid crystal panel 1403. These projection rays are backlight rays containing no image, and illuminate the liquid crystal panel 1403 at uniform illuminance. More specifically, the ray projector 1401 projects backlight rays to an image display unit 1402. The rays having passed through the liquid crystal panel 1403 of the image display unit enter an integrated lens 1404, displaying parallax images on a diffusion plate 1405. The backlight ray has directivity, and the liquid crystal panel is configured to be of the backlight type. Also in this case, rays emerging from the liquid crystal panel 1403 become equivalent to rays forming parallax image components projected from the image projector, as described above. A description of rays emerging from the liquid crystal panel 1403 is the same as that in the above-described embodiments, and will not be repeated.

As described above, according to the embodiments, the image display apparatus can achieve both stereopsis and high-quality parallax images.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. An image display apparatus comprising:
a ray projection unit configured to project first rays containing a plurality of parallax image components;
a ray angle change unit configured to receive the first rays projected from the ray projection unit, substantially collimate the first rays, and cause second rays to emerge; and
a parallax separation unit configured to receive the second rays emerging from the ray angle change unit, separate the parallax image components contained in the second rays at angles corresponding to the parallax image components, and project the parallax image components to a viewing area, the parallax separation unit including a lenticular lens in which a plurality of cylindrical lens elements are arrayed and boundaries are set between adjacent cylindrical lens elements,
wherein the parallax image components pass through areas of the cylindrical lens elements except for the boundaries.

2. The apparatus according to claim 1, wherein the ray angle change unit includes effective areas where the second rays emerge at an angle capable of parallax separation in the lenticular lens, and ineffective areas between the effective areas, and the parallax image components enter the effective areas.

3. The apparatus according to claim 2, wherein the ray angle change unit includes a Fresnel lens including a step between prism elements, and the ineffective area of the ray angle change unit corresponds to the step between the prism elements.

4. The apparatus according to claim 3, wherein the parallax image components enter an area except for the step of the Fresnel lens.

5. The apparatus according to claim 4, wherein the step of the Fresnel lens has a straight shape, and a direction of the step is parallel to the boundary of the lenticular lens.

6. The apparatus according to claim 4, wherein the Fresnel lens includes a plurality of steps parallel in at least two directions, and one direction of the step is parallel to the boundary of the lenticular lens.

7. The apparatus according to claim 1, wherein the ray angle change unit and the parallax separation unit are integrally formed.

8. The apparatus according to claim 2, wherein the ray angle change unit and the parallax separation unit are integrally formed.

9. The apparatus according to claim 3, wherein the ray angle change unit and the parallax separation unit are integrally formed.

10. The apparatus according to claim 4, wherein the ray angle change unit and the parallax separation unit are integrally formed.

11. The apparatus according to claim 5, wherein the ray angle change unit and the parallax separation unit are integrally formed.

12. The apparatus according to claim 6, wherein the ray angle change unit and the parallax separation unit are integrally formed.
